(19) United States
(12) Patent Application Publication
(10) Pub. No.: US 2024/0059435 A1
(43) Pub. Date: Feb. 22, 2024

(54) UNMANNED AERIAL VEHICLE CHARGING METHOD AND SYSTEM AND UNMANNED AERIAL VEHICLE

(71) Applicant: AUTEL ROBOTICS CO., LTD., Nanshan Dist (CN)

(72) Inventor: Wei QIN, Shenzhen (CN)

(21) Appl. No.: 18/452,792

(22) Filed: Aug. 21, 2023

(30) Foreign Application Priority Data
Aug. 19, 2022 (CN) 202210998960.6

(51) Int. Cl. B64U 50/37; B64D 35/02

(52) U.S. Cl. CPC B64U 50/37; B64D 35/02

(57) ABSTRACT

The present application relates to the field of power supply technologies, an unmanned aerial vehicle (UAV) charging method and system and a UAV. The method includes: controlling a UAV to be in a data transmission mode when a UAV battery is normally powered, and powering a UAV control system and a motor through the UAV battery; charging a supercapacitor module through the UAV battery until the supercapacitor module is fully charged; and controlling the UAV to be in a standby mode when it is detected that the UAV battery is removed, and powering the UAV control system and the motor through the supercapacitor module. The supercapacitor module is charged through the UAV battery during normal use of the UAV. The supercapacitor module discharges during replacement of the battery, with backup electric energy stored in the supercapacitor module generating a current to power the UAV control system and the motor.

### CROSS REFERENCE TO RELATED APPLICATION

This disclosure claims priority of Chinese Patent Application No. 202210998960.6, filed on Aug. 19, 2022 and entitled “Unmanned Aerial Vehicle Charging Method And System And Unmanned Aerial Vehicle,” the entire disclosure of which is incorporated herein by reference for all purposes.

### BACKGROUND

Limited by the development of lithium batteries, a battery life of an unmanned aerial vehicle (UAV) powered by the lithium batteries in consumer and industrial industries is generally short. In order to constantly work for long battery life, the battery needs to be replaced constantly, but the process of replacing the battery is often a process of power failure and restart. After the restart of a system, it is also necessary to re-set the frequency, update data, and the like, which often consumes an amount of time and is a relatively poor experience for a user with high efficiency requirements. Traditional UAV battery replacement is often restarted after power failure, but this method often wastes some time and affects execution efficiency of the UAV

### SUMMARY

The present application relates to the field of power supply technologies, and in particular, to an unmanned aerial vehicle (UAV) charging method and system and a UAV.

Implementations of the present application mainly solve a technical problem that an unmanned aerial vehicle (UAV) battery replacement often requires an entire UAV control system to be restarted after power failure, which affects execution efficiency of a UAV.

In order to resolve the technical problems, a technical solution adopted in the embodiments of the present application is as follows. A UAV charging method is provided, which is applicable to a UAV charging system. The UAV charging system includes a supercapacitor module, a UAV battery module and a power supply port, the UAV battery module including a UAV battery and a second isolation unit, the UAV battery being connected to the power supply port through the second isolation unit, an input terminal of the supercapacitor module being connected to an output terminal of the second isolation unit, and an output terminal of the supercapacitor module being connected to the power supply port, and the method includes: controlling the UAV to be in a data transmission mode when the UAV battery is normally powered, and powering a UAV control system and a motor through the UAV battery; charging a supercapacitor module through the UAV battery until the supercapacitor module is fully charged; and powering the UAV control system and the motor through the supercapacitor module when it is detected that the UAV battery is removed, until it is detected that the UAV battery is re-connected to the UAV charging system.

In the embodiments of the present disclosure, the supercapacitor module includes a supercapacitor unit, a first adjustment unit and a second adjustment unit, an input terminal of the supercapacitor unit being connected to an output terminal of the second isolation unit through the second adjustment unit, and an output terminal of the supercapacitor unit being connected to the power supply port through the first adjustment unit, and the charging the supercapacitor module through the UAV battery includes controlling the UAV battery to provide initial electric energy, and receiving and isolating the initial electric energy through the second isolation unit; and adjusting the initial electric energy through the second adjustment unit, and storing the adjusted initial electric energy to the supercapacitor unit.

In the embodiments of the present disclosure, the supercapacitor module further includes a capacitor protection unit, and the charging the supercapacitor module through the UAV battery further includes: detecting a voltage and a current of a power supply circuit of the supercapacitor unit through the capacitor protection unit; and cutting off the power supply circuit of the supercapacitor unit when an overvoltage and/or an overcurrent of the power supply circuit is detected.

In some embodiments of the present disclosure, when it is detected that the UAV battery is removed, the method further includes: controlling the UAV to be in a standby mode.

In some embodiments of the present disclosure, the controlling the UAV to be in a standby mode includes: saving data of the UAV in an operating state in a memory; and controlling the supercapacitor module to power the memory.

According to another aspect of the present disclosure, A UAV charging system is provided, which is applicable to a UAV and includes a supercapacitor module, a UAV battery module and a power supply port.

The UAV battery module includes a UAV battery and a second isolation unit. The UAV battery is connected to the power supply port through the second isolation unit, an input terminal of the supercapacitor module is connected to an output terminal of the second isolation unit, and an output terminal of the supercapacitor module is connected to the power supply port. The UAV battery is configured to provide an initial electric energy, the second isolation unit is configured to receive and isolate the initial electric energy and the supercapacitor module is configured to store backup electric energy based on the initial electric energy after isolation and provide the backup electric energy to the power supply port when the UAV battery is removed.

According to another aspect of the present disclosure. A UAV is provided. The UAV includes a UAV body. A UAV control system, a motor and the UAV charging system described above are arranged in the UAV body, the UAV charging system is electrically connected to the UAV control system and the motor, to power the UAV control system and the motor.

Different from the related technologies, the present application provides a UAV charging method and system and a UAV. The method includes: controlling the UAV to be in a data transmission mode when the UAV battery is normally powered, and powering a UAV control system and a motor through the UAV battery; charging a supercapacitor module through the UAV battery until the supercapacitor module is fully charged; and controlling the UAV to be in a standby mode when it is detected that the UAV battery is removed, and powering the UAV control system and the motor through the supercapacitor module. Based on the above method, the supercapacitor module is charged through the UAV battery during normal use of the UAV. The supercapacitor module discharges during replacement of the battery, with backup electric energy stored in the supercapacitor module generating a current to power the UAV control system and the motor. Upon completion of the replacement of the UAV battery, a new UAV battery is configured to charge the supercapacitor module in preparation for a next battery replacement. The UAV does not need to be powered off and restarted during the replacement of the battery of the UAV, which greatly improves operating efficiency of the UAV, especially for an unattended UAV application scenario.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a block diagram of an unmanned aerial vehicle (UAV) according to an embodiment of the present application.

FIG. 2 is a schematic flowchart of a UAV charging method according to an embodiment of the present application.

FIG. 3 is a structural block diagram of a UAV charging system according to an embodiment of the present application.

FIG. 4a is a schematic diagram of a circuit structure of a UAV battery module according to an embodiment of the present application.

FIG. 4b is a schematic diagram of a circuit structure of a power supply port according to an embodiment of the present application.

FIG. 5a is a schematic diagram of a circuit structure of a supercapacitor unit and a capacitor protection unit according to an embodiment of the present application.

FIG. 5b is another schematic diagram of a circuit structure of a supercapacitor unit and a capacitor protection unit according to an embodiment of the present application.

FIG. 6 is a schematic diagram of a circuit structure of a first buck-boost subunit according to an embodiment of the present application.

FIG. 7 is a schematic diagram of a circuit structure of a first isolation subunit according to an embodiment of the present application.

FIG. 8 is a schematic diagram of a circuit structure of a second buck-boost subunit according to an embodiment of the present application.

FIG. 9 is a schematic diagram of a circuit structure of a current-limiting and voltage-stabilizing subunit according to an embodiment of the present application.

### DETAILED DESCRIPTION

To make the objectives, technical solutions, and advantages of the present application clearer, the following further describes the present application in detail with reference to the accompanying drawings and the embodiments. It should be understood that the specific embodiments described herein are merely used to explain the present application but are not intended to limit the present application.

It should be noted that, if there is no conflict, the various features in the embodiments of the present application can be combined with each other, and are all within the protection scope of the present application. Moreover, although a division of functional modules is performed in a device schematic diagram and a logical order is shown in a flowchart, in some cases, the steps shown or described may be performed in a different order than the division of modules in the device schematic diagram, or in the flowchart. In addition, terms “first” and “second” are merely used for description and should not be understood as indicating or implying relative importance.

Unless otherwise defined, all technical and scientific terms used herein have the same meaning as commonly understood by one of ordinary skill in the art to which the present application belongs. Terms used in the specification of the present application are merely intended to describe objectives of the specific implementations, but are not intended to limit the present application. A term “and/or” used in this specification includes any or all combinations of one or more related listed items.

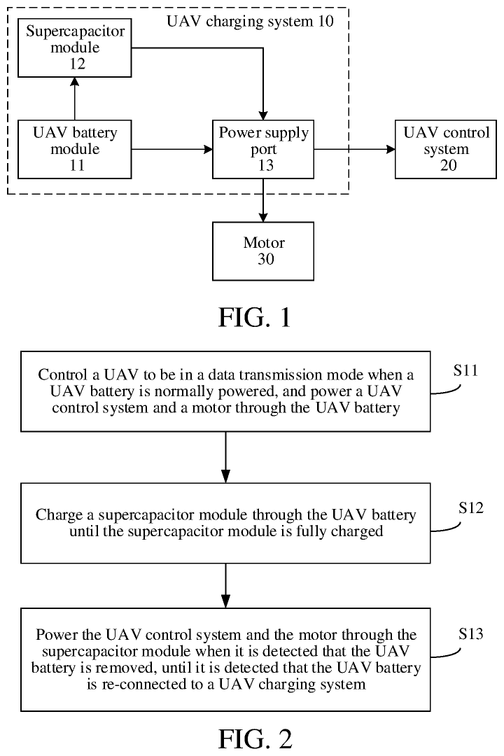

An embodiment of the present application provides an unmanned aerial vehicle (UAV). Referring to FIG. 1, the UAV includes a UAV body. A UAV control system 20, a motor 30 and a UAV charging system 10 are arranged on the UAV body. The UAV charging system 10 is electrically connected to the UAV control system 20 and the motor 30, to power the UAV control system 20 and the motor 30.

The UAV charging system 10 includes a UAV battery module 11, a supercapacitor module 12 and a power supply port 13. The UAV battery module 11 can provide power to the UAV control system 20 and the motor 30 through the power supply port 13. Moreover, the UAV battery module 11 can also charge the supercapacitor module 12. When the UAV needs to change the battery, the UAV battery module stops providing power through the power supply port 13. In this case, the supercapacitor module 12 can provide power through the power supply port 13, so that the UAV can complete a replacement of the UAV battery when the UAV control system 20 (the UAV control system is used as an example) is constantly powered, which greatly improves operation efficiency of the UAV, especially for an unattended UAV application scenario.

Referring to FIG. 2, an embodiment of the present application provides a UAV charging method. The method is applicable to the UAV charging system 10 and includes the following steps.

S11: Control a UAV to be in a data transmission mode when a UAV battery is normally powered, and power a UAV control system and a motor through the UAV battery.

When the UAV is normally powered, the power in the UAV battery is sufficient to support a normal use of the UAV, such as performing a flight task. In this case, the supercapacitor module does not need to be enabled.

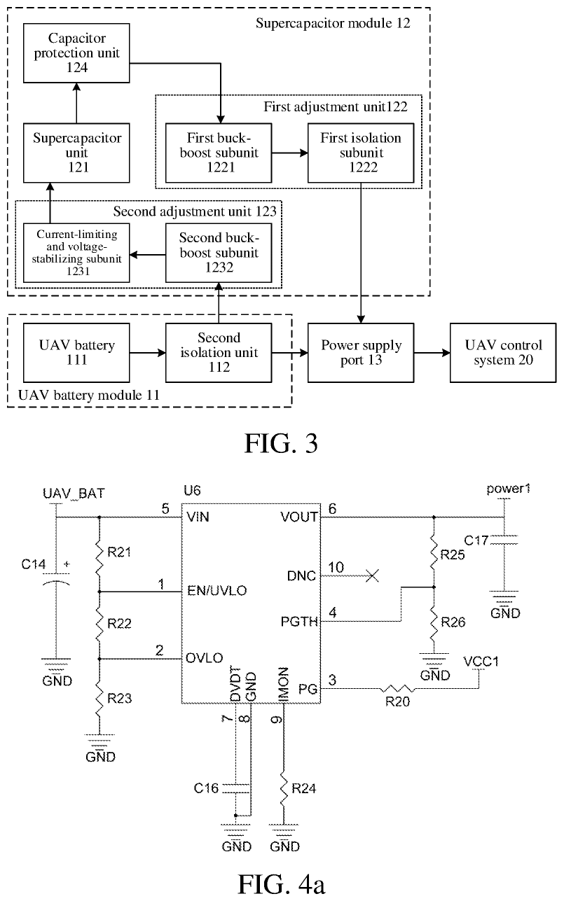

S12: Charge a supercapacitor module through the UAV battery until the supercapacitor module is fully charged. Referring to FIG. 3, the supercapacitor module includes a supercapacitor unit, a first adjustment unit and a second adjustment unit. An input terminal of the supercapacitor unit is connected to an output terminal of the second isolation unit through the second adjustment unit. An output terminal of the supercapacitor unit is connected to the power supply port through the first adjustment unit.

The charging the supercapacitor module through the UAV battery includes the following steps.

S121: Control the UAV battery to provide an initial electric energy, and receive and isolate the initial electric energy through the second isolation unit. The second isolation unit may be configured to receive and isolate the initial electric energy to prevent the system from a reverse current because the voltage of the backup electric energy of the supercapacitor module is inconsistent with the voltage of the initial electric energy of the UAV battery.

S122: Adjust the initial electric energy through the second adjustment unit and store the adjusted initial electric energy to the supercapacitor unit. The second adjustment unit may be configured to adjust the initial electric energy, so that the supercapacitor unit supports receiving and storing the adjusted initial electric energy; and the supercapacitor unit may be configured to receive and store the adjusted initial electric energy as a backup electric energy and to provide the backup electric energy to the power supply port after the UAV battery is removed.

S13: Power the UAV control system and the motor through the supercapacitor module when it is detected that the UAV battery is removed, until it is detected that the UAV battery is re-connected to the UAV charging system.

When the UAV battery is insufficient and a user needs to change the battery, the UAV battery module cannot supply power through the power supply port. In this case, the supercapacitor module can provide power through the power supply port, so that the UAV can complete a replacement of the UAV battery when the UAV control system (the UAV control system is used as an example) is constantly powered.

When it is detected that the UAV battery is removed, the method further includes the following steps.

S130: Control the UAV to be in a standby mode. Specifically, the controlling the UAV to be in a standby mode includes the following steps.

S131: Save data of the UAV in an operating state in a memory.

S132: Control the supercapacitor module to power the memory.

When replacing the UAV battery, due to a small power of the supercapacitor module, the electric energy provided to the power supply port is usually less than the electric energy provided by the UAV battery directly to the power supply port. In this case, the UAV needs to be switched from the data transmission mode to the standby mode to reduce power consumption and avoid transmission data loss caused by power failure. While before replacing the battery, the UAV may be performing a task or just finished performing a task, the data of the operating state of the UAV needs to be stored in the memory, and the memory is powered to save the data. When the battery is replaced, the UAV may continue to perform the task based on the data.

In some embodiments, the supercapacitor module further includes a capacitor protection unit. The charging the supercapacitor module through the UAV battery further includes:
detecting a voltage and a current of a power supply circuit of the supercapacitor unit through the capacitor protection unit; and cutting off the power supply circuit of the supercapacitor unit when an overvoltage and/or an overcurrent of the power supply circuit is detected. The capacitor protection unit may be configured to detect a voltage and a current of a power supply circuit of the supercapacitor unit and cut off the power supply circuit of the supercapacitor unit when an overvoltage and/or an overcurrent is detected, so as to protect the supercapacitor unit.

According to the UAV charging method in an embodiment of the present application, the supercapacitor module is charged through the UAV battery during normal use of the UAV. The supercapacitor module discharges during replacement of the battery, with backup electric energy stored in the supercapacitor module generating a current to power the UAV control system and the motor. Upon completion of the replacement of the UAV battery, a new UAV battery is configured to charge the supercapacitor module in preparation for a next battery replacement. The UAV does not need to be powered off and restarted during the replacement of the battery of the UAV, which greatly improves operating efficiency of the UAV, especially for an unattended UAV application scenario.

Referring to FIG. 3, an embodiment of the present application provides a UAV charging system, which can be applicable to the UAV in the above embodiment. The UAV charging system includes a UAV battery module 11, a supercapacitor module 12 and a power supply port 13. An output terminal of the UAV battery module 11 is connected to the power supply port. An input terminal of the supercapacitor module 12 is connected to an output terminal of the UAV battery module 11. An output terminal of the supercapacitor module 12 is connected to the power supply port 13. The power supply port 13 is connected to a UAV main control system and/or a motor. In this embodiment, that the power supply port 20 is connected to the UAV main control system is used as an example.

Specifically, the UAV battery module 11 includes a UAV battery 111 and a second isolation unit 112. An input terminal of the second isolation unit 112 is connected to the UAV battery 111. An output terminal of the second isolation unit 112 is connected to the power supply port 13. The UAV battery 111 may be configured to provide an initial electric energy. The second isolation unit 112 may be configured to receive and isolate the initial electric energy to prevent the system from a reverse current because the voltage of the backup electric energy of the supercapacitor module is inconsistent with the voltage of the initial electric energy of the UAV battery. The supercapacitor module 12 may be configured to store backup electric energy based on the initial electric energy after isolation and provide the backup electric energy to the power supply port 13 when the UAV battery 111 is removed, so that the UAV can complete a replacement of the UAV battery when the UAV control system 20 is constantly powered.

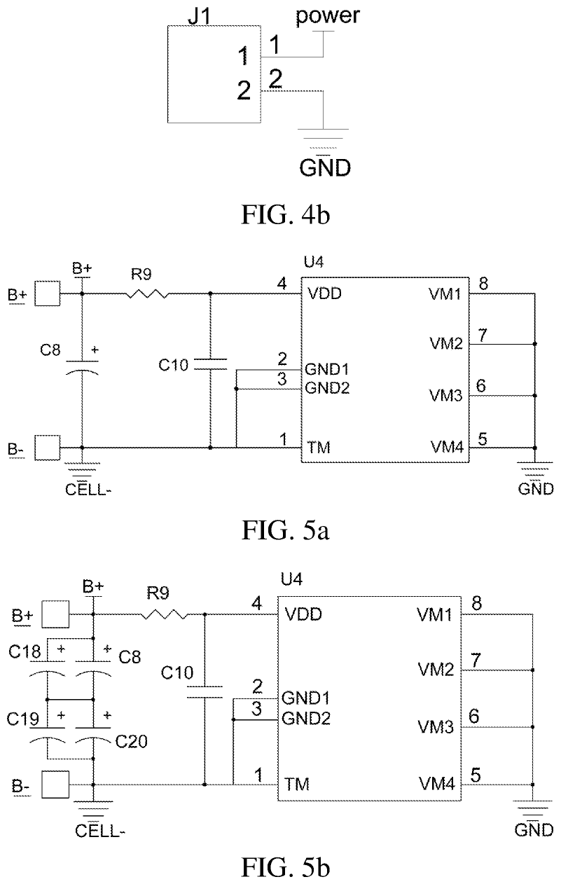

Referring to FIG. 4a and FIG. 4b, FIG. 4a is a schematic diagram of a circuit structure of a UAV battery module 11, and FIG. 4b is a schematic diagram of a circuit structure of a power supply port according to an embodiment of the present application. As shown in the figure, a capacitor C14 represents a UAV battery and UAV BAT represents a voltage of an initial electric energy provided by the UAV battery in FIG. 4a. The second isolation unit may be a chip U6 and a chip circuit as shown in the figure. The chip U6 is a control chip for an isolating diode, such as a chip of an LM7310 model. The chip of this model may be configured as an analog current monitor and includes an integrated FET with on/off control, reverse current blocking and reverse polarity protection. In FIG. 4b, J1 represents a power supply port 13. In the figure, power1 represents an initial electric energy after an isolation process of the second isolation unit, that is, the power supply electric energy provided by the UAV battery to the UAV control system/motor when the UAV battery is not removed.

It should be noted that, in the embodiment of the present application, in addition to the power supply port for the UAV battery through the second isolation unit, the supercapacitor module may further power the power supply port when the UAV battery is removed. For ease of description, in the drawings attached to the present application, the initial electric energy isolated by the second isolation unit is represented as power1, and the backup electric energy provided by the supercapacitor module to the power supply port is represented as power2. The two are collectively referred to as an electric energy in FIG. 4b, representing the electric energy provided to the UAV control system (or the motor) through the power supply port.

In some other embodiments, the second isolation unit 112 may also be a second isolation diode assembly. The second isolation diode assembly may include one or more diode devices. Each of the diode devices is arranged based on a direction in which the UAV battery provides power to the power supply port and/or the supercapacitor module, so as to avoid a reverse current in the system.

Referring to FIG. 3, the supercapacitor module 12 includes a supercapacitor unit 121, a first adjustment unit 122 and a second adjustment unit 123. An input terminal of the second adjustment unit 123 is connected to an output terminal of the second isolation unit 112. An output terminal of the second adjustment unit 123 is connected to an input terminal of the supercapacitor unit 121. An output terminal of the supercapacitor unit 121 is connected to an input terminal of the first adjustment unit 122. An output terminal of the first adjustment unit 122 is connected to the power supply port 13.

The second adjustment unit 123 may be configured to adjust the initial electric energy, so that the supercapacitor unit 121 supports receiving and storing the adjusted initial electric energy. The supercapacitor unit 121 may be configured to receive and store the adjusted initial electric energy as backup electric energy and to provide the backup electric energy to the first adjustment unit 122 after the UAV battery 111 is removed. The first adjustment unit 122 may be configured to adjust the voltage of the backup electric energy and provide the backup electric energy to the power supply port 13.

Specifically, the supercapacitor unit includes one or more supercapacitors, where the plurality of supercapacitors are connected in series and/or in parallel. In some embodiments, the supercapacitor unit 121 is usually connected with a capacitor protection unit 124. The supercapacitor unit 121 is connected to the first adjustment unit 122 through the capacitor protection unit 124. The capacitor protection unit 124 may be configured to detect a voltage and a current of a power supply circuit of the supercapacitor unit 121 and cut off the power supply circuit of the supercapacitor unit 121 when an overvoltage and/or an overcurrent is detected, so as to protect the supercapacitor unit 121.

Referring to FIG. 5a and FIG. 5b, FIG. 5a is a schematic diagram of a circuit structure of a single supercapacitor and a capacitor protection unit according to an embodiment of the present application. In the figure, the supercapacitor is represented by the capacitor C8, and the backup electric energy stored by the supercapacitor unit is represented by B+(and B−). The capacitor protection unit may be a chip U4 and a chip circuit as shown in the figure. The chip U4 is a battery protection chip, such as a chip of a SC5510D model. The chip of the model can provide high-precision voltage and current protection, including overvoltage protection, undervoltage protection, charge overcurrent, discharge overcurrent, discharge short circuit protection and thermal shutdown protection functions. FIG. 5b is a schematic diagram of a circuit structure of a plurality of supercapacitors and a capacitor protection unit according to an embodiment of the present application. In the figure, the supercapacitor unit is represented by a capacitor C8, a capacitor C18, a capacitor C19 and a capacitor C20 connected in parallel/in series. It may be understood that a quantity and connection mode of supercapacitors in the supercapacitor unit may be selected based on an actual use scenario, which are not limited in this embodiment of the present application.

The first adjustment unit 122 includes a first buck-boost subunit 1221 and a first isolation subunit 1222. Referring to FIG. 3, an input terminal of the first buck-boost subunit 1221 is connected to an output terminal of the supercapacitor unit 121, an output terminal of the first buck-boost subunit 1221 is connected to an input terminal of the first isolation subunit 1222 and an output terminal of the first isolation subunit 1222 is connected to the power supply port 13.

The first buck-boost subunit 1221 may be configured to adjust the voltage of the backup electric energy, so that the backup electric energy meets the power demand of the UAV control system 20. The first isolation subunit 1222 is configured to receive and isolate the backup electric energy and provide the isolated backup electric energy to the power supply port 13.

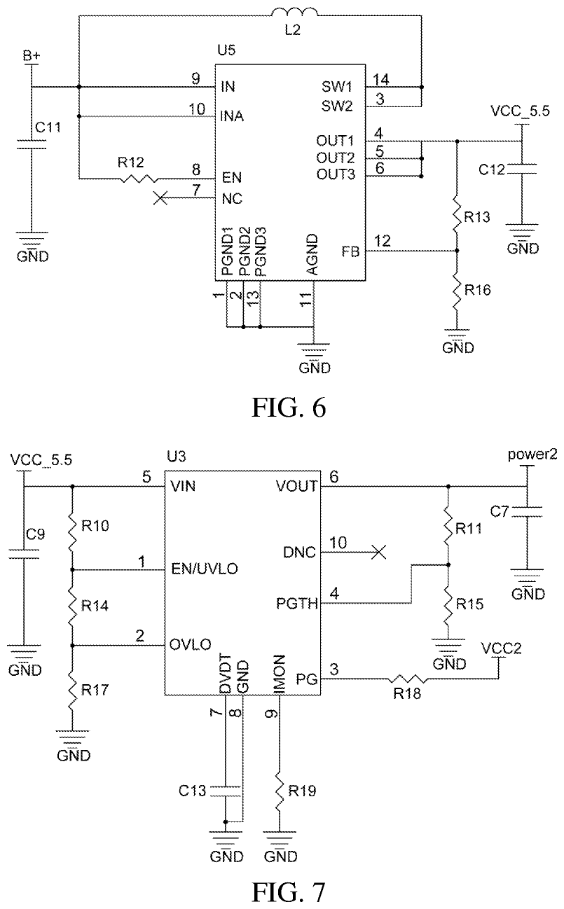

Referring to FIG. 6, FIG. 6 is a schematic diagram of a circuit structure of a first buck-boost subunit 1221 according to an embodiment of the present application, including a chip U5 and a chip circuit as shown in the figure. The chip U5 is a boost-buck control chip, such as a chip of model MP3423. The chip of the model has a high-efficiency boost switch function and an input-output disconnect function, may be configured to provide overcurrent protection, short circuit protection, overvoltage protection and overtemperature protection, and ensure safety of the supercapacitor unit while adjusting the voltage of the backup electric energy. In the figure, VCC_5.5 represents a voltage of the backup electric energy adjusted by the first buck-boost subunit. It should be noted that the value 5.5 is only an example of a voltage value provided by this embodiment, and is not a limitation of the voltage value.

Referring to FIG. 7, in some embodiments, the first isolation subunit 1222 may be the first isolation chip U3 and the chip circuit as shown in the figure. The first isolation chip U3 and the chip circuit can limit a power transmission direction, such as a chip of an LM7310 model. For ease of description, the backup electric energy after the isolation process of the first isolation subunit is represented by power2 in the figure. It should be noted that FIG. 7 is only an example of a circuit structure of the first isolation subunit according to the embodiment. In some other embodiments, the first isolation subunit may also be another circuit structure with a function of preventing the reverse current, such as a second isolation diode assembly.

The second adjustment unit 123 includes a second buck-boost subunit 1232 and a current-limiting and voltage-stabilizing subunit 1231. Referring to FIG. 3, an input terminal of the second buck-boost subunit 1232 is connected to an output terminal of the second isolation unit 112, an output terminal of the second buck-boost subunit 1232 is connected to an input terminal of the current-limiting and voltage-stabilizing subunit 1231 and an output terminal of the current-limiting and voltage-stabilizing subunit 1231 is connected to an input terminal of the supercapacitor unit 121.

The second buck-boost subunit 1232 may be configured to adjust the voltage of the initial electric energy after the isolation processing by the second isolation unit, so that the supercapacitor unit 121 can support receiving and storing the adjusted initial electric energy. The current-limiting and voltage-stabilizing subunit 1231 may be configured to detect a voltage and a current of a charging circuit of the supercapacitor unit 121 and cut off the charging circuit of the supercapacitor unit 121 when an overvoltage and/or an overcurrent is detected, so as to protect the supercapacitor unit. The charging circuit of the supercapacitor unit 121 may represent a circuit part for charging the supercapacitor unit for the UAV battery in this embodiment.

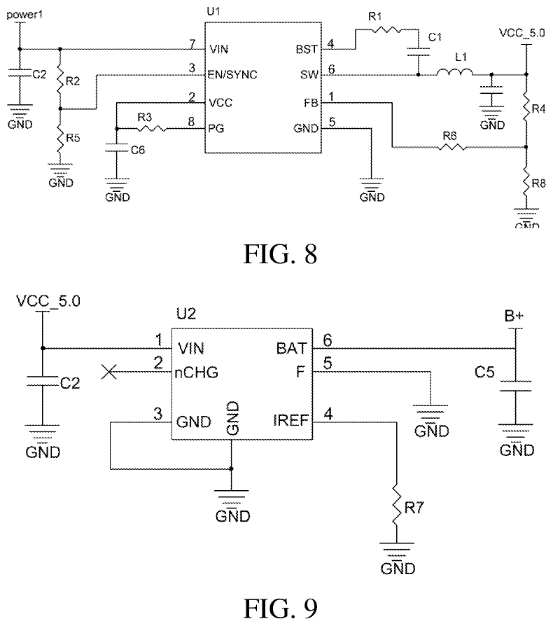

Referring to FIG. 8, FIG. 8 is a schematic diagram of a circuit structure of a second buck-boost subunit according to an embodiment of the present application. A chip U1 and a chip circuit as shown may perform buck-boost regulation on initial electric energy. The chip may for example be a BQ25700 chip. Specifically, the chip and the chip circuit may assume a buck configuration, a boost configuration, or a buck-boost configuration during power-on based on an initial voltage and a condition of a supercapacitor, and is capable of automatic switching among the buck configuration, the boost configuration, and the buck-boost configuration without control by a host. In addition, the unit may also be a chip of MP4423H related model with a high-frequency synchronous rectification and buck function. In the figure, VCC_5.0 represents a voltage of the initial electric energy adjusted by the second buck-boost subunit. It should be noted that the value 5.0 is only an example of a voltage value provided by this embodiment, and is not a limitation of the voltage value.

Referring to FIG. 9, FIG. 9 is a schematic diagram of a circuit structure of a current-limiting and voltage-stabilizing subunit according to an embodiment of the present application, including a chip U2 and a chip circuit as shown in the figure. The chip U2 is a charge management control chip with a current limiting and voltage stabilizing function, such as a chip of a model SGM4056, which can adjust the initial electric energy after adjusting the second buck-boost subunit to charge the supercapacitor unit.

Specifically, the UAV charging system provided by the embodiment of the present application can charge the supercapacitor unit through the UAV battery when the UAV is in normal use (that is, when the UAV battery is not replaced). The current at a positive end of the UAV battery charges the supercapacitor unit through the second buck-boost subunit and the current-limiting and voltage-stabilizing subunit, and stores the backup electric energy in the supercapacitor. When the battery is replaced (that is, within a period of time when the UAV battery is removed), the supercapacitor unit discharges, and the reserve backup electric energy generates current, which passes through the first adjustment unit to the power supply port to provide power to the UAV control system and the motor. Upon completion of the replacement of the UAV battery, a new UAV battery is configured to charge the supercapacitor unit in preparation for a next battery replacement. During the battery change process, the UAV does not need to be powered off and restarted, and does not need to be manually powered up and controlled, which greatly improves operation efficiency of the UAV, especially for an unattended UAV application scenario.

Finally, it should be noted that: the foregoing embodiments are merely used for describing the technical solutions of the present application, but are not intended to limit the present application. Under the ideas of the present application, the technical features in the foregoing embodiments or different embodiments may also be combined, the steps may be performed in any order, and many other changes of different aspects of the present application also exists as described above, and these changes are not provided in detail for simplicity. Although the present application is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of the present application.

What is claimed is:

1. An unmanned aerial vehicle charging method, applicable to an unmanned aerial vehicle charging system, wherein the an unmanned aerial vehicle charging system comprises a supercapacitor module, a unmanned aerial vehicle battery module and a power supply port, the unmanned aerial vehicle battery module comprises a unmanned aerial vehicle battery and a second isolation unit, the unmanned aerial vehicle battery being connected to the power supply port through the second isolation unit, an input terminal of the supercapacitor module being connected to an output terminal of the second isolation unit, and an output terminal of the supercapacitor module being connected to the power supply port, and the method comprises:
controlling the unmanned aerial vehicle to be in a data transmission mode when the unmanned aerial vehicle battery is normally powered, and powering an unmanned aerial vehicle control system and a motor through the unmanned aerial vehicle battery;
charging the supercapacitor module through the unmanned aerial vehicle battery until the supercapacitor module is fully charged; and
powering the unmanned aerial vehicle control system and the motor through the supercapacitor module when it is detected that the unmanned aerial vehicle battery is removed, until it is detected that the unmanned aerial vehicle battery is re-connected to the unmanned aerial vehicle charging system.

2. The charging method according to claim 1, wherein the supercapacitor module comprises a supercapacitor unit, a first adjustment unit and a second adjustment unit, an input terminal of the supercapacitor unit being connected to an output terminal of the second isolation unit through the second adjustment unit, and an output terminal of the supercapacitor unit being connected to the power supply port through the first adjustment unit, and the charging the supercapacitor module through the unmanned aerial vehicle battery comprises:
controlling the UAV battery to provide initial electric energy, and receiving and isolating the initial electric energy through the second isolation unit; and
adjusting the initial electric energy through the second adjustment unit, and storing the adjusted initial electric energy to the supercapacitor unit.

3. The charging method according to claim 2, wherein the supercapacitor module further comprises a capacitor protection unit, and the charging the supercapacitor module through the unmanned aerial vehicle battery further comprises:
detecting a voltage and a current of a power supply circuit of the supercapacitor unit through the capacitor protection unit; and
cutting off the power supply circuit of the supercapacitor unit when an overvoltage and/or an overcurrent of the power supply circuit is detected.

4. The charging method according to claim 1, wherein the removal of the unmanned aerial vehicle battery is detected, the method further comprises:
controlling the UAV to be in a standby mode.

5. The charging method according to claim 4, wherein the controlling the UAV to be in a standby mode comprises:
saving data of the unmanned aerial vehicle in an operating state in a memory; and
controlling the supercapacitor module to power the memory.

6. An unmanned aerial vehicle charging system, applicable to an unmanned aerial vehicle, and an unmanned aerial vehicle charging system comprising: a supercapacitor module, a UAV battery module and a power supply port,
the unmanned aerial vehicle battery module comprising an unmanned aerial vehicle battery and a second isolation unit, the unmanned aerial vehicle battery being connected to the power supply port through the second isolation unit, an input terminal of the supercapacitor module being connected to an output terminal of the second isolation unit, an output terminal of the supercapacitor module being connected to the power supply port,
the unmanned aerial vehicle battery being configured to provide initial electric energy, the second isolation unit being configured to receive and isolate the initial electric energy, and the supercapacitor module being configured to store backup electric energy based on the initial electric energy after isolation and provide the backup electric energy to the power supply port when the unmanned aerial vehicle battery is removed.

7. The unmanned aerial vehicle charging system according to claim 6, wherein the supercapacitor module comprises a supercapacitor unit, a first adjustment unit and a second adjustment unit,
an input terminal of the second adjustment unit being connected to an output terminal of the second isolation unit, an output terminal of the second adjustment unit being connected to an input terminal of the supercapacitor unit, an output terminal of the supercapacitor unit being connected to an input terminal of the first adjustment unit, and an output terminal of the first adjustment unit being connected to the power supply port;
the second adjustment unit being configured to adjust the initial electric energy, so that the supercapacitor unit supports receiving and storage of the adjusted initial electric energy;
the supercapacitor unit being configured to receive and store the adjusted initial electric energy as backup electric energy and provide the backup electric energy for the first adjustment unit after the UAV battery is removed; and
the first adjustment unit being configured to adjust a voltage of the backup electric energy.

8. The unmanned aerial vehicle charging system according to claim 7, wherein the supercapacitor module further comprises a capacitor protection unit, the supercapacitor unit being connected to the first adjustment unit through the capacitor protection unit, and the capacitor protection unit being configured to detect a voltage and a current of a power supply circuit of the supercapacitor unit and cut off the power supply circuit of the supercapacitor unit when an overvoltage and/or an overcurrent is detected, so as to protect the supercapacitor unit.

9. The unmanned aerial vehicle charging system according to claim 7, wherein the first adjustment unit comprises a first buck-boost subunit and a first isolation subunit,
an input terminal of the first buck-boost subunit being connected to an output terminal of the supercapacitor unit, an output terminal of the first buck-boost subunit being connected to an input terminal of the first isolation subunit, and an output terminal of the first isolation subunit being connected to the power supply port; and
the first buck-boost subunit being configured to adjust a voltage of the backup electric energy, and the first isolation subunit being configured to receive and isolate the backup electric energy and provide the isolated backup electric energy for the power supply port.

10. The unmanned aerial vehicle charging system according to claim 7, wherein the second adjustment unit comprises:
a second buck-boost subunit, a current-limiting and voltage-stabilizing subunit,
an input terminal of the second buck-boost subunit being connected to an output terminal of the second isolation unit, an output terminal of the second buck-boost subunit being connected to an input terminal of the current-limiting and voltage-stabilizing subunit, and an output terminal of the current-limiting and voltage-stabilizing subunit being connected to an input terminal of the supercapacitor unit;
the second buck-boost subunit being configured to adjust a voltage of the initial electric energy, so that the supercapacitor unit supports receiving and storage of the adjusted initial electric energy; and
the current-limiting and voltage-stabilizing subunit being configured to detect a voltage and a current of a charging circuit of the supercapacitor unit and cut off the charging circuit of the supercapacitor unit when an overvoltage and/or an overcurrent is detected, so as to protect the supercapacitor unit.

11. An unmanned aerial vehicle, comprising an unmanned aerial vehicle body, an unmanned aerial vehicle control system, a motor, and the unmanned aerial vehicle charging system, the unmanned aerial vehicle charging system being electrically connected to the unmanned aerial vehicle control system and the motor, to power the UAV control system and the motor, wherein the unmanned aerial vehicle charging system comprising: a supercapacitor module, a UAV battery module and a power supply port,
the unmanned aerial vehicle battery module comprising an unmanned aerial vehicle battery and a second isolation unit, the unmanned aerial vehicle battery being connected to the power supply port through the second isolation unit, an input terminal of the supercapacitor module being connected to an output terminal of the second isolation unit, an output terminal of the supercapacitor module being connected to the power supply port,
the unmanned aerial vehicle battery being configured to provide initial electric energy, the second isolation unit being configured to receive and isolate the initial electric energy, and the supercapacitor module being configured to store backup electric energy based on the initial electric energy after isolation and provide the backup electric energy to the power supply port when the unmanned aerial vehicle battery is removed.

12. An unmanned aerial vehicle according to claim 11, wherein the supercapacitor module comprises a supercapacitor unit, a first adjustment unit and a second adjustment unit,
an input terminal of the second adjustment unit being connected to an output terminal of the second isolation unit, an output terminal of the second adjustment unit being connected to an input terminal of the supercapacitor unit, an output terminal of the supercapacitor unit being connected to an input terminal of the first adjustment unit, and an output terminal of the first adjustment unit being connected to the power supply port;
the second adjustment unit being configured to adjust the initial electric energy, so that the supercapacitor unit supports receiving and storage of the adjusted initial electric energy;
the supercapacitor unit being configured to receive and store the adjusted initial electric energy as backup electric energy and provide the backup electric energy for the first adjustment unit after the UAV battery is removed; and
the first adjustment unit being configured to adjust a voltage of the backup electric energy.

13. An unmanned aerial vehicle according to claim 12, wherein the supercapacitor module further comprises:
a capacitor protection unit;
the supercapacitor unit, the supercapacitor unit being connected to the first adjustment unit through the capacitor protection unit;
the capacitor protection unit, the capacitor protection unit being configured to detect a voltage and a current of a power supply circuit of the supercapacitor unit and cut off the power supply circuit of the supercapacitor unit when an overvoltage and/or an overcurrent is detected, so as to protect the supercapacitor unit.

14. An unmanned aerial vehicle according to claim 12, wherein the first adjustment unit comprises:
a first buck-boost subunit and a first isolation subunit;
an input terminal of the first buck-boost subunit being connected to an output terminal of the supercapacitor unit, an output terminal of the first buck-boost subunit being connected to an input terminal of the first isolation subunit, and an output terminal of the first isolation subunit being connected to the power supply port; and
the first buck-boost subunit being configured to adjust a voltage of the backup electric energy, and the first isolation subunit being configured to receive and isolate the backup electric energy and provide the isolated backup electric energy for the power supply port.

15. An unmanned aerial vehicle according to claim 12, wherein the second adjustment unit comprises:
a second buck-boost subunit, a current-limiting and voltage-stabilizing subunit,
an input terminal of the second buck-boost subunit being connected to an output terminal of the second isolation unit, an output terminal of the second buck-boost subunit being connected to an input terminal of the current-limiting and voltage-stabilizing subunit, and an output terminal of the current-limiting and voltage-stabilizing subunit being connected to an input terminal of the supercapacitor unit;
the second buck-boost subunit being configured to adjust a voltage of the initial electric energy, so that the supercapacitor unit supports receiving and storage of the adjusted initial electric energy; and
the current-limiting and voltage-stabilizing subunit being configured to detect a voltage and a current of a charging circuit of the supercapacitor unit and cut off the charging circuit of the supercapacitor unit when an overvoltage and/or an overcurrent is detected, so as to protect the supercapacitor unit.
